(19) United States
(12) Patent Application Publication
(10) Pub. No.: US 2023/0174900 A1
(43) Pub. Date: Jun. 8, 2023

(54) POLYMER COMPOSITION, WHICH IS SUITABLE AS ANTI-GREYING AGENT IN DETERGENT FORMULATIONS

(71) Applicant: BASF SE, Ludwigshafen am Rhein (DE)

(72) Inventors: Roland ETTL, Ludwigshafen (DE); Thomas WEISS, Ludwigshafen (DE); Gabriele BOENEMANN, Ludwigshafen (DE); Volker KREIDER, Ludwigshafen (DE); Aaron WAGNER, Ludwigshafen (DE)

(21) Appl. No.: 17/995,510

(22) PCT Filed: Apr. 6, 2021
(86) PCT No.: PCT/EP2021/058860

§ 371 Date: Oct. 5, 2022

(30) Foreign Application Priority Data
Apr. 7, 2020 (EP) 20168472.7

(51) Int. Cl. C11D 3/00; C11D 11/00; C11D 3/22; C11D 3/37; C11D 17/00

(52) U.S. Cl. CPC C11D 3/0036; C11D 3/225; C11D 3/3765; C11D 11/0017; C11D 17/003

(57) ABSTRACT

Disclosed herein are aqueous polymer compositions, which are obtainable by radical copolymerization in water; a process for producing the aqueous polymer compositions; a method of using the aqueous polymer compositions as an anti-greying additive in washing or laundry; a method of using the aqueous polymer compositions as an anti-greying additive in liquid laundry detergent formulations or gel-type laundry detergent formulations; and a liquid laundry detergent formulation or gel-type laundry detergent formulation, which contains at least one aqueous polymer composition.

The present invention relates to a polymer composition, which is obtainable by radical copolymerization of ethylenically unsaturated monomers M in the presence of carboxymethylcellulose. The invention also relates to the use of these polymer compositions as anti-greying additives in detergent formulations, in particular in liquid laundry detergent formulations.

During the washing process of laundry, cleaning performance may be adversely affected by redeposition of soil onto the fabrics. The redeposition of the soil will lead to a general greying of textiles. In order to reduce redeposition of soil, native or modified polysaccharides have been suggested as anti-greying additives. The most prominent anti-greying additive is carboxymethylcellulose (CMC), which has already been suggested in the 1930’s. The anti-redeposition/anti-greying effect of CMC is not always satisfactory. WO 2009/154934 suggests a CMC having a specific degree of substitution and a specific degree of blockiness for providing a higher anti-redeposition/anti-greying effect in laundry detergents.

The use of CMC is however limited since they have a high viscosity in water and tend to gelling when formulated in liquid laundry detergent compositions. Moreover, liquid detergent formulations may become instable by formation insoluble matter or suffering from phase separation, when containing CMC. Therefore, CMC is typically used as an anti-greying additive only in powder detergent compositions. On the other hand, liquid detergent compositions are more gentle on textiles than powder detergents, but disadvantage of greying over many washing cycles is more pronounced. Greying becomes particularly visible on white textiles after 30 or more washes. In this regard, cotton, which is still the most common textile in the laundry basket, poses a particular problem. Although the use of cellulases reduces greying on cotton, they are not effective enough to prevent it. Therefore, there is a need for providing an additive, which has an anti-greying effect and which, in particular, can be formulated with a liquid detergent formu-lation.

WO 2015/091160 describes polysaccharides based on hemicellulose or starch modified by treatment with gaseous or liquid SO₂. The modified polysaccharides provide acceptable anti-greying effect and do not impart the stability of liquid laundry detergent formulations.

WO 2016/079003 describes a rheology modifier obtained by copolymerization of at least one carboxylic acid, at least one monomer selected from C₁-C₂-alkyl methacrylates and C₁-C₄-alkyl acrylate in the presence of a polysaccharide, which is preferably present in an amount of less than 75 parts by weight, per 100 parts by weight of monomers. The polymer compositions described therein provide a thickening effect, but do not have an anti-greying effect.

It was surprisingly found that the aqueous polymer compositions described herein provide for a high anti-greying effect when used in detergent formulations and thus can be used as an additive in detergent formulations, in particular in laundry detergent formu-lations. In contrast to conventional carboxymethylcellulose, the aqueous polymer compositions do not impart instability to liquid laundry detergent formulations and thus is particularly useful as an anti-greying additive in liquid laundry detergent formulations.

A first aspect of the invention relate to aqueous polymer compositions, which are obtainable by radical copolymerization in water of
i) ethylenically unsaturated monomers M comprising
   a.1) 50 to 95% by weight, in particular 60 to 93% by weight, more particularly 65 to 92% by weight, especially 70 to 90% by weight or 75 to 90% by weight, based on the total weight of the monomers M, of at least one monomer M1, selected from the group consisting of C1-C₃-alkyl esters of acrylic acid and C1-C₃-alkyl esters of methacrylic acid and mixtures thereof, and
   a.2) 5 to 50% by weight, in particular 7 to 40% by weight, more particularly 8 to 35% by weight, especially 10 to 30% by weight or 10 to 25% by weight, based on the total weight of the monomers M, of at least one monomer M2, selected from the group consisting of monoethylenically unsaturated C₃-C₈-monocarboxylic acids and monoethylenically unsaturated C₄-C₈-dicarboxylic acids, and mixtures thereof; in the presence of
ii) 110 to 600% by weight, in particular 130 to 500% by weight, more particularly 150 to 480% by weight and especially 170 to 450% by weight, based on the total amount of monomers M, of a carboxymethylcellulose.

A further aspect of the present invention is a process for producing the aqueous polymer compositions of the present invention, which comprises a radical polymerization of the monomers M in water in the presence of 110 to 600% by weight, in particular 130 to 500% by weight, more particularly 150 to 480% by weight and especially 170 to 450% by weight, based on the total amount of monomers M, of a carboxymethylcellulose.

Further aspects of the present invention relate to
the use of the aqueous polymer compositions as defined herein as an anti-greying additive in the washing or laundry;
the use of the aqueous polymer compositions as defined herein as an anti-greying additive in laundry detergent formulations, in particular in liquid laundry detergent formulations or gel-type laundry detergent formulations;
laundry detergent formulations, in particular liquid or gel-type laundry detergent formulations, which contain at least one aqueous polymer composition as defined herein.

The present invention is associated with several benefits. First of all, the aqueous polymer compositions of the invention provide good anti-greying effect, which is comparable to that of those carboxymethylcellulose grades frequently used as anti-greying additives in laundry detergent compositions. Contrary to carboxymethylcellulose, the aqueous polymer compositions of the invention are compatible with liquid detergent compositions, in particular with liquid laundry detergent compositions and do not impart instability to them, such as phase separation and undesirable increase in viscosity. Moreover, the aqueous polymer compositions of the invention can have a very low viscosity, in particular compared to an aqueous solution of the carboxymethylcellulose having a similar content of carboxymethylcellulose. Therefore, they can be easily incorporated in liquid detergent compositions, in particular with liquid laundry detergent compositions.

Here and throughout the application, the following technical terms have their usual meanings. For example
Cₙ-Cₘ in the context of a generically defined radical refers to the possible number of carbon atoms in this radical;
Cₙ-Cₘ alkyl refers to saturated acyclic carbon radicals, which have n to m carbon atoms and which are linear or branched;
C₁-C₃ alkyl refers to saturated acyclic carbon radicals, which have 1 to 3 carbon atoms and which are linear or branched, e. g. methyl, ethyl, n-propyl or isopropyl. Similarly, C₂-C₃ alkyl refers to saturated acyclic carbon radicals, which have 2 or 3 carbon atoms and which are linear or branched, e. g. ethyl, n-propyl or isopropyl.
The term “ethylenically unsaturated” in the context of a monomer refers to an organic compound, which has at least one C═C double bond, is not part of an aromatic ring and thus can be subjected to a radical polymerization.
The term “monoethylenically unsaturated C₃-C₈ monocarboxylic acid” refers to a monobasic carboxylic acid having 3 to 8 C atoms, in particular 3 to 6 carbon atoms, which has a single ethylenically unsaturated C═C double bond. Examples of monoethylenically unsaturated C₃-C₈ monocarboxylic acids include but are not limited to acrylic acid, methacrylic acid, vinylacetic acid, crotonic acid and mixtures thereof.
The term “monoethylenically unsaturated C₄-C₈ dicarboxylic acid” refers to a dibasic carboxylic acid having 4 to 8 C atoms, in particular 3 to 6 carbon atoms, which has one ethylenically unsaturated C═C double bond. Examples of monoethylenically unsaturated C₄-C₈ dicarboxylic acids include but are not limited to maleic acid, fumaric acid, itaconic acid, mesaconic acid, citraconic acid and mixtures thereof.

According to the invention, the aqueous polymer compositions are obtained by radical copolymerisation of ethylenically usaturated monomers M in water in the presence of a carboxylmethyl cellulose. In this copolymerization, an aqueous composition of a copolymer will be formed, wherein the copolymer chains have repeating units of the polymerized monomers M subjected to the radical copolymerization, i.e. of both polymerized monomers M1 and polymerized monomers M2. In addition, the polymer composition contains carboxylmethylcellulose. The polymer compositions of the present invention, however, are distinct from simple physical mixtures obtained by mixing an aqueous omposition of copolymer formed by the copolymerized monomers M and an aquous composition of carboxylmethylcellulose. Rather, the copolymer composition will contain a carboxymethylcellulose, which is modified by copolymer chains formed from the polymerized monomers M. These copolymer chains are formed from the monomers M and may be covalently bound to the carboxymethylcellulose molecules and/or may be entrapped by the carboxymethylcelulose molecules and/or may entrap the carboxymethylcellulose molecules. In any case, the relative amounts of the copolymer chains formed by the monomers M to carboxymethylcellulose and also the relative amounts of polymerized monomers M1 and M2 within the copolymer chains essentially correspond to the relative amounts of monomers M1, M2 and carboxylmethylcellulose subjected to the radical copolymerization of monomers M in water in the presence of carboxylmethylcellulose.

Preferably, the monomers M1 comprise at least one monomer M1a, which is selected from the group consisting of methyl methacrylate and methyl acrylate and mixtures thereof. In particular, the monomer M1a is methyl methacrylate or a mixture of methyl methacrylate and methyl acrylate, where the mixture preferably comprises at least 50% by weight, in particular at least 70% by eight especially at least 90% by weight, based on the total amount of monomers M1a, of methyl methacrylate. The remainder of monomers M1a, if any, is then methyl acrylate. Especially, the monomer M1a is methyl methacrylate.

In addition to the monomer M1a, the monomers M1 preferably comprise at least one further monomer M1b, which is selected from the group consisting of C₂-C₃-alkyl esters of acrylic acid and C₂-C₃-alkyl esters of methacrylic acid. Suitable C₂-C₃-alkyl esters of acrylic acid are ethyl acrylate, n-propyl acrylate and isopropyl acrylate. Suitable C₂-C₃-alkyl esters of acrylic acid are ethyl methacrylate, n-propyl methacrylate and isopropyl methacrylate. Preferably, the monomers M1b comprise at least 50% by weight, in particular at least 70% by weight, especially at least 90% by weight, based on the total amount of monomers M1b, of at least one C₂-C₃-alkyl ester of acrylic acid. The remainder of monomers M1b, if any, is then preferably a C₂-C₃-alkyl ester of methacrylic acid. More preferably, the monomers M1b comprise at least 50% by weight, in particular at least 70% by weight, especially at least 90% by weight, based on the total amount of monomers M1b, of ethyl acrylate. The remainder of monomers M1b, if any, is then preferably selected from the group consisting of C₃-alkyl acrylate and C₂-C₃-alkyl esters of methacrylic acid. Especially, the monomer M1b is ethyl methacrylate.

If the monomers M1 comprise at least one monomer M1a and at least one monomer M1b, the weight ratio of the monomer M1a to the monomer M1b is preferably in the range from 1:2 to 3:1, in particular in the range from 1:1 to 2.5:1 and especially in the range from 1.2:1 to 2:1.

In a preferred group of embodiments, the monomers M1 comprise at least 50% by weight, in particular at least 70% by weight, especially at least 90% by weight or 100% by weight, based on the total amount of monomers M1, of a combination of
at least one monomer M1a, which is selected from the group consisting of methyl methacrylate and methyl acrylate and mixtures thereof;
and at least one monomer M1b, which is selected from C₂-C₃-alkyl esters of acrylic acid and which is in particular ethyl acrylate.

In a very preferred group of embodiments, the monomers M1 comprise at least 50% by weight, in particular at least 70% by weight, especially at least 90% by weight or 100% by weight, based on the total amount of monomers M1, of a combination of
methyl methacrylate;
and at least one monomer M 1b, which is selected from C₂-C₃-alkyl esters of acrylic acid and which is in particular ethyl acrylate.

In the preferred and very preferred groups of embodiments, the weight ratio of the monomer M1a to the monomer M1b is preferably in the range from 1:2 to 3:1, in particular in the range from 1:1 to 2.5:1 and especially in the range from 1.2:1 to 2:1.

In addition to the monomers M1, the monomers M comprise 5 to 50% by weight, in particular 7 to 40% by weight, more particularly 8 to 35% by weight, especially 10 to 30% by weight or 10 to 25% by weight, based on the total weight of the monomers M, of at least one monomer M2. The monomers M2 are preferably selected from the group consisting of monoethylenically unsaturated C₃-C₆-monocarboxylic acids and more preferably from the group consisting of acrylic acid, methacrylic acid and mixtures thereof. In particular, the monomers M2 are selected from methacrylic acid and mixtures thereof with acrylic acid, which comprise at least 50% by weight, in particular at least 70% by weight, especially at least 90% by weight, based on the total amount of monomers M2, of methacrylic acid.

Preferably, the total amount of monomers M1 and M2 amounts to at least 70% by weight, in particular at least 75% by weight, of the total weight of monomers M. In a preferred group (1) of embodiments, the total amount of monomers M1 and M2 is at least 90% by weight, in particular at least 95% by weight and especially at least 99% by weight or 100% by weight, based on the total weight of monomers M. In another preferred group (2) of embodiments, the total amount of monomers M1 and M2 is in the range of 70 to 99% by weight, in particular in the range of 75 to 98% by weight, especially in the range of 80 to 95% by weight, based on the total weight of monomers M.

In a particularly preferred group (1a) of embodiments, the monomers M comprise
a.1) 50 to 95% by weight, in particular 60 to 93% by weight, more particularly 70 to 92% by weight, especially 75 to 90% by weight, based on the total weight of the monomers M, of at least one monomer M1 comprising at least 50% by weight, in particular at least 70% by weight, especially at least 90% by weight or 100% by weight, based on the total amount of monomers M1, of a combination of
   at least one monomer M1a, which is selected from the group consisting of methyl methacrylate and methyl acrylate and mixtures thereof; and
   and at least one monomer M1b, which is selected from C₂-C₃-alkyl esters of acrylic acid and which is in particular ethyl acrylate;
   and
a.2) 5 to 50% by weight, in particular 7 to 40% by weight, more particularly 8 to 30% by weight, especially 10 to 25% by weight, based on the total weight of the monomers M, of at least one monomer M2, selected from monoethylenically unsaturated C₃-C₆-monocarboxylic acids and more preferably from the group consisting of acrylic acid, methacrylic acid and mixtures thereof.

In a very particularly preferred group (1b) of embodiments, the monomers M comprise
a.1) 50 to 95% by weight, in particular 60 to 93% by weight, more particularly 70 to 92% by weight, especially 75 to 90% by weight, based on the total weight of the monomers M, of at least one monomer M1 comprising at least 50% by weight, in particular at least 70% by weight especially at least 90% by weight or 100% by weight, based on the total amount of monomers M1, of a combination of
   methyl methacrylate;
   and at least one monomer M1b, which is selected from C₂-C₃-alkyl esters of acrylic acid and which is in particular ethyl acrylate;
   and
a.2) 5 to 50% by weight, in particular 7 to 40% by weight, more particularly 8 to 30% by weight, especially 10 to 25% by weight, based on the total weight of the monomers M, of at least one monomer M2, selected from monoethylenically unsaturated C₃-C₆-monocarboxylic acids and more preferably from the group consisting of acrylic acid, methacrylic acid and mixtures thereof.

In an especially preferred group (1c) of embodiments, the monomers M comprise
a.1) 50 to 95% by weight, in particular 60 to 93% by weight, more particularly 70 to 92% by weight, especially 75 to 90% by weight, based on the total weight of the monomers M, of at least one monomer M1 comprising at least 50% by weight, in particular at least 70% by weight, especially at least 90% by weight or 100% by weight, based on the total amount of monomers M1, of a combination of
   methyl methacrylate; and
   and at least one monomer M1b, which is selected from C₂-C₃-alkyl esters of acrylic acid and which is in particular ethyl acrylate;
   and
a.2) 5 to 50% by weight, in particular 7 to 40% by weight, more particularly 8 to 30% by weight, especially 10 to 25% by weight, based on the total weight of the monomers M, of at least one monomer M2, selected from methacrylic acid and mixtures thereof with acrylic acid, which comprise at least 50% by weight, in particular at least 70% by weight, especially at least 90% by weight, based on the total amount of monomers M2, of methacrylic acid.

In a very especially preferred group (1d) of embodiments, the monomers M comprise
a.1) 50 to 95% by weight, in particular 60 to 93% by weight, more particularly 70 to 92% by weight, especially 75 to 90% by weight, based on the total weight of the monomers M, of at least one monomer M1 comprising at least 50% by weight, in particular at least 70% by weight, especially at least 90% by weight or 100% by weight, based on the total amount of monomers M1, of a combination of
   methyl methacrylate; and
   ethyl acrylate;
   and
a.2) 5 to 50% by weight, in particular 7 to 40% by weight, more particularly 8 to 30% by weight, especially 10 to 25% by weight, based on the total weight of the monomers M, of methacrylic acid.

In the particularly preferred, very particularly preferred, especially preferred and very especially preferred groups (1), (1a), (1b), (1c) and (1d) of embodiments, the weight ratio of the monomer M1a to the monomer M1b is preferably in the range from 1:2 to 3:1, in particular in the range from 1:1 to 2.5:1 and especially in the range from 1.2:1 to 2:1.

In the particularly preferred, very particularly preferred, especially preferred and very especially preferred groups (1), (1a), (1b), (1c) and (1d) of embodiments, the monomers M1 and M2 amount to at least 90% by weight, in particular at least 95% by weight and especially at least 99% by weight or 100% by weight of the monomers M.

The monomerd M may optionally comprise one or more further ethylenically unsaturated monomers, which are different from the monomer M1 and M2, which are hereinafter referred to as monomers M3.

The amount of the monomers M3, will usually not exceed 30% by weight and is preferably at most 25% by weight and especially at most 20% by weight, based on the total weight of the monomers M. In group (1) of embodiments, the amount of the monomers M3 will not exceed 10% by weight and is preferably at most 5% by weight and especially at most 1% by weight or even 0% by weight, based on the total weight of the monomers M. In group (2) of embodiments, the amount of the monomers M3 is usually in the range of 1 to 30% by weight, in partiuclar in the range of 2 to 25% by weight and especially in the range of 5 to 20% by weight, based on the total weight of the monomers M.

Suitable monomers M3, if present, are in particular monoethylenically unsaturated non-ionic monomers M3a, monoethylenically unsaturated anionic monomers M3b having an anionic group which is different from a carboxyl group, and monomers M3c, which are esters of monoethylenically unsaturated C₃-C₈ monocarboxylic acids with C₄-C₁₀ alkanols.

Monomers M3a include, but are not limited to
primary amides of monoethylenically unsaturated C₃-C₈ monocarboxylic acids, in particular acrylamide and methacrylamide;
amides and diamides of monoethylenically unsaturated C₃-C₈ monocarboxylic acids, in particular of acrylic acid or methacrylic acid, with C₁-C₄ alkylamines or di-C₁-C₄ alkylamines, such as N-methyl acrylamide, N-ethyl acrylamide, N-propyl acrylamide, N-isopropyl acrylamide, N-butyl acrylamide, N-methyl methacrylamide, N-ethyl methacrylamide, N-propyl methacrylamide, N-isopropyl methacrylamide and N-butyl methacrylamide;
hydroxy-C₂-C₄-alkyl esters of monoethylenically unsaturated C₃-C₈ monocarboxylic acids, in particular of acrylic acid or methacrylic acid, such as 2-hydroxyethyl (meth)acrylate, 3-hydroxypropyl (meth)acrylate and 4-hydroxybutyl (meth)acrylate;
esters of monoethylenically unsaturated C₄-C₈ dicarboxylic acids with C₁-C₁₀ alkanols and mixtures thereof, such as dimethyl maleate, diethyl maleate, di(n-propyl) maleate, diisopropyl maleate, di(n-butyl) maleate, di(n-hexyl) maleate, di(1,1,3,3-tetramethylbutyl) maleate, di(n-nonyl) maleate, and dimethyl fumarate.

The term “(meth)acrylate” here embraces both the corresponding ester of acrylic acid and the corresponding ester of methacrylic acid.

Preferably, the amount of monomers M3a does not exceed 10% by weight, in particular 5% by weight, based on the total amount of monomers M.

In monomers M3b the anionic groups are in particular the sulfonate groups (SO₃-), phosphate groups (OPO₃²⁻ ) and phosphonate groups (PO₃²⁻). Examples of monomers M3b include, but are not limited to
monoethylenically unsaturated sulfonic acids and salts thereof, such as vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids and 2-acrylamido-2-methylpropanesulfonic acid, especially salts thereof, specifically the sodium salts thereof;
monoethylenically unsaturated monomers having a phosphate or phosphonate group and salts thereof, such as vinylphosphonic acid, allylphosphonic acid, 2-phosphonoethyl acrylate, 2-phosphonoethyl methacrylate, phosphonopropyl acrylate, phosphonopropyl methacrylate, styrenephosphonic acids, 2-acrylamido-2-methylpropanephosphonic acid, and phosphoric monoesters of the hydroxy-C₂-C₄-alkyl esters of monoethylenically unsaturated C₃-C₈ monocarboxylic acids specified hereinafter, for example the phosphoric monoesters of 2-hydroxyethyl (meth)acrylate, 3-hydroxypropyl (meth)acrylate, 4-hydroxybutyl (meth)acrylate, and especially the salts of the aforementioned monoethylenically unsaturated monomers having a phosphate or phosphonate group, specifically the sodium salts thereof.

Preferably, the amount of monomers M3b does not exceed 1% by weight, based on the total amount of monomers M.

Examples of monomers M3c include, but are not limited to n-butyl (meth)acrylate, sec-butyl (meth)acrylate, tert-butyl (meth)acrylate, tert-butyl ethacrylate, n-hexyl (meth)acrylate, n-heptyl (meth)acrylate, n-octyl (meth)acrylate, 1,1,3,3-tetramethylbutyl (meth)acrylate, ethylhexyl (meth)acrylate, n-nonyl (meth)acrylate and n-decyl (meth)acrylate. Amongst monomers M3c, preference is given to the esters of acrylic acid or methacrylic acid with C₄-C₁₀ alkanols, in particular to the esters of acrylic acid or methacrylic acid with C₄-C₆ alkanols, and especially to the esters of acrylic acid with n-C₄-C₆ alkanols, such as n-butyl acrylate.

If present, the amount of monomers M3c is generally in the range of 1 to 30% by weight, in particular in the range of 2 to 25% by weight, especially in the range of 5 to 20% by weight, based on the total weight of the monomers M.

In a preferred group (2a) of embodiments, the monomers M comprise
a.1) 50 to 94% by weight, in particular 60 to 91% by weight, especially 65 to 85% by weight, based on the total weight of the monomers M, of at least one monomer M1 comprising at least 50% by weight, in particular at least 70% by weight, especially at least 90% by weight or 100% by weight, based on the total amount of monomers M1, of a combination of
   at least one monomer M1a, which is selected from the group consisting of methyl methacrylate and methyl acrylate and mixtures thereof; and
   and at least one monomer M1b, which is selected from C₂-C₃-alkyl esters of acrylic acid and which is in particular ethyl acrylate;
a.2) 5 to 49% by weight, in particular 7 to 38% by weight, especially 10 to 25% by weight, based on the total weight of the monomers M, of at least one monomer M2, selected from monoethylenically unsaturated C₃-C₆-monocarboxylic acids and more preferably from the group consisting of acrylic acid, methacrylic acid and mixtures thereof; and
a.3) 1 to 30% by weight, in particular 2 to 25% by weight, especially 5 to 20% by weight, based on the total weight of the monomers M, of at least one monomer M3c, which is preferably selected from the group consisting of the esters of acrylic acid or methacrylic acid with C₄-C₁₀ alkanols, in particular from the esters of acrylic acid or methacrylic acid with C₄-C₆ alkanols, and especially from the esters of acrylic acid with n-C₄-C₆ alkanols, such as n-butyl acrylate.

In a particularly preferred group (2b) of embodiments, the monomers M comprise
a.1) 50 to 94% by weight, in particular 60 to 91% by weight, especially 65 to 85% by weight, based on the total weight of the monomers M, of at least one monomer M1 comprising at least 50% by weight, in particular at least 70% by weight especially at least 90% by weight or 100% by weight, based on the total amount of monomers M1, of a combination of
   methyl methacrylate;
   and at least one monomer M1b, which is selected from C₂-C₃-alkyl esters of acrylic acid and which is in particular ethyl acrylate;
a.2) 5 to 49% by weight, in particular 7 to 38% by weight, especially 10 to 25% by weight, based on the total weight of the monomers M, of at least one monomer M2, selected from monoethylenically unsaturated C₃-C₆-monocarboxylic acids and more preferably from the group consisting of acrylic acid, methacrylic acid and mixtures thereof; and
a.3) 1 to 30% by weight, in particular 2 to 25% by weight, especially 5 to 20% by weight, based on the total weight of the monomers M, of at least one monomer M3c, which is selected from the group consisting of the esters of acrylic acid or methacrylic acid with C₄-C₁₀ alkanols, in particular from the esters of acrylic acid or methacrylic acid with C₄-C₆ alkanols, and especially from the esters of acrylic acid with n-C₄-C₆ alkanols, such as n-butyl acrylate.

In a very particularly preferred group (2c) of embodiments, the monomers M comprise
a.1) 50 to 94% by weight, in particular 60 to 91% by weight, especially 65 to 85% by weight, based on the total weight of the monomers M, of at least one monomer M1 comprising at least 50% by weight, in particular at least 70% by weight, especially at least 90% by weight or 100% by weight, based on the total amount of monomers M1, of a combination of
   methyl methacrylate; and
   and at least one monomer M1b, which is selected from C₂-C₃-alkyl esters of acrylic acid and which is in particular ethyl acrylate;
a.2) 5 to 49% by weight, in particular 7 to 38% by weight, especially 10 to 25% by weight, based on the total weight of the monomers M, of at least one monomer M2, selected from methacrylic acid and mixtures thereof with acrylic acid, which comprise at least 50% by weight, in particular at least 70% by weight, especially at least 90% by weight, based on the total amount of monomers M2, of methacrylic acid; and
a.3) 1 to 30% by weight, in particular 2 to 25% by weight, especially 5 to 20% by weight, based on the total weight of the monomers M, of at least one monomer M3c, which is selected from the group consisting of the esters of acrylic acid with C₄-C₆ alkanols, more particularly from the esters of acrylic acid with n-C₄-C₆ alkanols, especially n-butyl acrylate.

In an especially preferred group (2d) of embodiments, the monomers M comprise
a.1) 50 to 94% by weight, in particular 60 to 91% by weight, especially 65 to 85% by weigth, based on the total weight of the monomers M, of at least one monomer M1 comprising at least 50% by weight, in particular at least 70% by weight, especially at least 90% by weight or 100% by weight, based on the total amount of monomers M1, of a combination of
   methyl methacrylate; and
   ethyl acrylate;
a.2) 5 to 49% by weight, in particular 7 to 38% by weight, especially 10 to 25% by weight, based on the total weight of the monomers M, of methacrylic acid; and
a.3) 1 to 30% by weight, in particular 2 to 25% by weight, especially 5 to 20% by weight, based on the total weight of the monomers M, of at least one monomer M3c, which is n-butyl acrylate.

In group (2) of embodiments, and also in the preferred, very particularly preferred, especially preferred groups (2a), (2b), (2c) and (2d) of embodiments, the weight ratio of the monomer M1a to the monomer M1b is preferably in the range from 1:2 to 3:1, in particular in the range from 1:1 to 2.5:1 and especially in the range from 1.2:1 to 2:1.

In group (2) of embodiments, and also in the preferred, very particularly preferred, especially preferred groups (2a), (2b), (2c) and (2d) of embodiments, the monomers M1, M2 and M3c amount to at least 90% by weight, in particular at least 95% by weight and especially at least 99% by weight or 100% by weight of the monomers M.

According to the invention, the polymer composition is obtained by radical copolymerization of the monomers M in water in the presence of carboxymethylcellulose.

Principally, any carboxymethylcellulose is suitable. In particular, the carboxymethylcellulose as its sodium salt has a weight average molecular weight Mw in the range from 10000 to 1500000 Dalton, in particular in the range from 15000 to 1000000 Dalton, especially in the range from 20000 to 500000 Dalton. The number average molecular mass of the sodium salt, such as carboxymethylcellulose, is typically in the range from 3000 to 250000, in particular in the range from 4000 to 200000 and especially in the range from 5000 to 180000. The dispersity, i.e. the ratio of M_{N}/M_{w}, is usually in the range from 3 to 15, in particular in the range from 4 to 12. The molecular weights given here refer to the values as determined by field flow fractionation of a 0.5% by weight solution of the carboxymethylcellulose in a 0.1 M solution of NaNOs in deionized water at 25° C.

Usually, the carboxymethylcellulose is characterized in that 2% by weight solution of its sodium salt in deionized water has a Brookfield viscosity in the range from 10 to 20000 mPas, in particular in the range from 15 to 10000 mPas, especially in the range from 20 to 5000 mPas. The viscosity values herein refer to the values determined by a Brookfield rotational viscometer according to DIN ISO 2555:2018-09 at 25° C. and rotational speed of 20 rotations per minute using spindle RV5.

Usually, the carboxymethylcellulose has a degree of anionic substitution in the range from 0.5 to 1.5, in particular in the range from 0.6 to 1.3 and especially in the range from 0.6 to 1.0. The degree of substation relates to the number average of carboxymethyl groups, i.e. groups of the formula CH₂COOH, per glucose repeating unit of the carboxymethylcellulose.

Carboxymethylcellulose having the aforementioned properties is well known and can be prepared from cellulose by polymer analogue reaction comprising an alkali hydroxide treatment, also termed mercerization, followed by reaction with monochloroacetic acid and subsequent removal of the by products (see e.g. Römpp Lexikon Chemie, Band 1, 10. Auflage, Georg Thieme Verlag Stuttgart 1996 - 1999, and the references cited therein; A. Nussinovitch, Hydrcolloid Applications, Sprincer-Science + Business Media, B.V, Dordrecht, 1997, pp. 112 - 123 and the references cited therein). Suitable carboxymethylcellulose is also commercially available. Examples of commercially available carboxymethylcellulose are the carboxymethylcellulose products available under the following brand names: Finnfix® grades 5, 10, 30, 300, 700, 2000, 4000, 10000 and the Cekol® grades 5, 10, 30, 300, 700, 2000, 4000, 10000 of Kelco and the Walocel® grades CRT 100, CRT 1000, CRT 2000, CRT 10000 and CRT 20000 of Dupont.

As explained above, the aqueous polymer composition of the present invention contains a copolymer of a carboxymethylcellulose, which is modified by copolmyer chains formed from the polymerized monomers M. This copolymer may be virtually dissolved in the aqueous phase of the aqueous polymer composition or may form latex particles dispersed in the aqueous phase. In particular, the polymer particles have a volume median particle diameter (also termed as D(v 0.5)value) as determined by static light scattering (SLS) of at most 500 nm, in particular at most 350 nm. In particular, the D(v 0.5) value is in the range from 50 to 500 nm, more preferably in the range from 70 to 350 nm and especially in the range from 80 to 300 nm. Frequently, the aqueous polymer dispersions have a particle size distribution, wherein the D(v, 0.1) value is in the range of 20 to 150 nm, in particular in the range from 30 to 120 nm. Frequently, the aqueous polymer dispersions have a particle size distribution, wherein the D(v, 0.9) value is at most 600 nm, preferably at most 500 nm, especially at most 450 nm and e.g. in the range of 150 to 600 nm, preferably in the range from 170 to 500 nm and especially in the range from 200 to 450 nm.

Here and throughout the specification, the terms “particle size” and “particle diameter” are used synonymously and relate to the particle size as determined by static light scattering of the diluted aqueous dispersion in accordance with ISO 13320:2009. This also applies to the particle size distribution, which can be characterized e.g. by the following values D[v, 0.1], D[v, 0.5], D[v, 0.9], D[4.3] and D[3.2]. In the context, the value D[v, 0.1] means that 10 Vol.-% of the particles in the probe have a particle size below the value given as D[v, 0.1] value. Correspondingly, the value D[v, 0.5] means that 50 Vol.-% of the particles in the probe have a particle size below the value given as D[v, 0.5] value, and the value D[v, 0.9] means that 90 Vol.-% of the particles in the probe have a particle size below the value given as D[v, 0.9] value. The value D[4.3] is the volume or mass moment mean, also termed as De Broucker mean. The value D[3, 2] is the surface area moment mean, also termed the Sauter mean diameter.

In addition to the copolymer, the aqueous polymer compositions may contain one or more emulsifiers. These emulsifiers are usually present in an amount of 0.1 to 5% by weight, in particular in an amount of 0.3 to 4% by weight and especially in an amount of 0.5 to 3% by weight, based on the total weight of monomers M. The emulsifiers serve for stabilizing the emulsion of the monomers M during copolymerization and also of the polymer particles formed in the copolymerization of the monomers M. In contrast to the carboxymethylcellulose, emulsifiers typically have lower molecular weights, in particular number average molecular weights of below 1000 g/mol. The emulsifier may be anionic or nonionic or mixtures of non-ionic and anionic emulsifiers.

Suitable anionic emulsifiers usually bear at least one anionic group, which is selected from phosphate, phosphonate, sulfate and sulfonate groups. The anionic emulsifier, which bear at least one anionic group, are typically used in the form of their alkali metal salts, especially of their sodium salts or in the form of their ammonium salts.

Preferred anionic emulsifiers are anionic emulsifiers, which bear at least one sulfate or sulfonate group. Likewise, anionic emulsifiers, which bear at least one phosphate or phosphonate group may be used, either as sole anionic emulsifiers or in combination with one or more anionic emulsifiers, which bear at least one sulfate or sulfonate group.

Examples of anionic emulsifiers, which bear at least one sulfate or sulfonate group, are, for example,
the salts, especially the alkali metal and ammonium salts, of alkyl sulfates, especially of C₈-C₂₂-alkyl sulfates,
the salts, especially the alkali metal and ammonium salts, of sulfuric monoesters of C₂-C₃-alkoxylated alkanols, especially of sulfuric monoesters of C₂-C₃-alkoxylated C₈-C₂₂-alkanols, preferably having an C₂-C₃-alkoxylation level (AO level) in the range from 2 to 40,
the salts, especially the alkali metal and ammonium salts, of sulfuric monoesters of C₂-C₃-alkoxylated alkylphenols, especially of sulfuric monoesters of C₂-C₃-alkoxylated C₄-C₁₈-alkylphenols (AO level preferably 3 to 40),
the salts, especially the alkali metal and ammonium salts, of alkylsulfonic acids, especially of C₈-C₂₂-alkylsulfonic acids,
the salts, especially the alkali metal and ammonium salts, of dialkyl esters, especially di-C₄-C₁₈-alkyl esters of sulfosuccinic acid,
the salts, especially the alkali metal and ammonium salts, of alkylbenzenesulfonic acids, especially of C₄-C₂₂-alkylbenzenesulfonic acids, and
the salts, especially the alkali metal and ammonium salts, of mono- or disulfonated, alkyl-substituted diphenyl ethers, for example of bis(phenylsulfonic acid) ethers bearing a C₄-C₂₄-alkyl group on one or both aromatic rings. The latter are common knowledge, for example from US-A-4,269,749, and are commercially available, for example as Dowfax® 2A1 (Dow Chemical Company).

The above-mentioned term C₂-C₃-alkoxylated means that the compounds are ethoxylated, propoxylated or co-ethoxylated/propoxylated. In other words, the term C₂-C₃-alkoxylated means that the respective compounds are obtained by a process, which introduces a polyethylenoxide group, a polypropyleneoxide group or a poly(ethyleneoxide-co-propyleneoxide) group.

Examples of anionic emulsifiers, which bear a phosphate or phosphonate group, include, but are not limited to the following salts, are selected from the following groups:
the salts, especially the alkali metal and ammonium salts, of mono- and dialkyl phosphates, especially C₈-C₂₂-alkyl phosphates,
the salts, especially the alkali metal and ammonium salts, of phosphoric monoesters of C₂-C₃-alkoxylated alkanols, preferably having an alkoxylation level in the range from 2 to 40, especially in the range from 3 to 30, for example phosphoric monoesters of ethoxylated C₈-C₂₂-alkanols, preferably having an ethoxylation level (EO level) in the range from 2 to 40, phosphoric monoesters of propoxylated C₈-C₂₂-alkanols, preferably having a propoxylation level (PO level) in the range from 2 to 40, and phosphoric monoesters of ethoxylated-co-propoxylated C₈-C₂₂-alkanols, preferably having an ethoxylation level (EO level) in the range from 1 to 20 and a propoxylation level of 1 to 20,
the salts, especially the alkali metal and ammonium salts, of phosphoric monoesters of C₂-C₃-alkoxylated alkylphenols, especially phosphoric monoesters of C₂-C₃-alkoxylated C₄-C₁₈-alkylphenols (AO level preferably 3 to 40),
the salts, especially the alkali metal and ammonium salts, of alkylphosphonic acids, especially C₈-C₂₂-alkylphosphonic acids and
the salts, especially the alkali metal and ammonium salts, of alkylbenzene-phosphonic acids, especially C₄-C₂₂-alkylbenzenephosphonic acids.

Preferred anionic emulsifiers are selected from the following groups:
the salts, especially the alkali metal and ammonium salts, of alkyl sulfates, especially of C₈-C₂₂-alkyl sulfates,
the salts, especially the alkali metal salts, of sulfuric monoesters of C₂-C₃-alkoxylated alkanols, especially of sulfuric monoesters of C₂-C₃-alkoxylated C₈-C₂₂-alkanols, preferably having an AO level in the range from 2 to 40,
of sulfuric monoesters of C₂-C₃-alkoxylated alkylphenols, especially of sulfuric monoesters of C₂-C₃-alkoxylated C₄-C₁₈-alkylphenols (AO level preferably 3 to 40),
of alkylbenzenesulfonic acids, especially of C₄-C₂₂-alkylbenzenesulfonic acids, and
of mono- or disulfonated, alkyl-substituted diphenyl ethers, for example of bis(phenylsulfonic acid) ethers bearing a C₄-C₂₄-alkyl group on one or both aromatic rings.

Suitable emulsifiers may also be nonionic emulsifiers. Suitable nonionic emulsifiers are e.g. araliphatic or aliphatic nonionic emulsifiers, for example
C₂-C₃-alkoxylated mono-, di- and trialkylphenols (AO level: 3 to 50, alkyl radical: C₄-C₁₀),
C₂-C₃-alkyoxlates, thus ethoxylates, propoxylates or ethoxylate-co-propoxylates, of long-chain alcohols (AO level: 3 to 100, alkyl radical: C₈-C₃₆), and
polyethylene oxide/polypropylene oxide homo- and copolymers. These may comprise the alkylene oxide units copolymerized in random distribution or in the form of blocks.

The solids content of the aqueous polymer compsoition is usually in the range from 5 to 50% by weight and in particular in the range from 10 to 40% by weight, especially in the range of 15 to 35% by weight, based on the total weight of the aqueous polymer composition.

The viscosity of the aqueous polymer composition will depend from the solid content but is preferably in the range from 20 to 2000 mPas, in particular in the range from 50 to 1000 mPas and especially in the range form 70 to 700 mPas. The viscosity values given here refer to Brookfield viscosities as determined according to DIN ISO 2555:2018-09 at 25° C. at pH 4.5 - 5.0 and rotational speed of 20 rotations per minute using spindle RT3.

As the polymer contained in the aqueous polymer composition of the invention contains a considerable amount of carboxymethylcellulose, the copolymers are at least partially biodegradable or at least can be eliminated from the sewage plant effluent together with the sewage sludge.

The present invention also relates to a process for producing polymer dispersions as defined above. The process comprises a radical copolymerization, in particular a free radical copolymerization, of the monomers M in water in the presence of the required amount of carboxymethylcellulose. According to the invention, the required amount is in the range from 110 to 600% by weight, in particular 130 to 500% by weight, more particularly 150 to 480% by weight and especially 170 to 450% by weight, based on the total amount of monomers M, which are copolymerized.

According to the invention, the copolymerization is carried out in water, i.e. the monomers M to be copolymerized and the carboxymethylcellulose are present in an aqueous reaction medium, when the copolymerization is carried out.

For the properties of the aqueous polymer composition, it is beneficial if the carboxymethylcellulose is present in hydrated form. For this, the carboxymethylcellulose is used in the form of an aqueous solution, preferably in the form of an aqueous solution of the sodium salt of carboxymethylcellulose. The aqueous solution of carboxymethylcellulose, in particular of its sodium salt, is usually prepared by mixing carboxymethylcellulose, in particular its sodium salt, with water, which may contain one or more of the aforementioned emulsifiers. Typically mixing is achieved by stirring to allow a complete hydration of the carboxymethylcellulose. To achieve complete dissolution, the carboxymethylcellulose is preferably mixed with water for at least 4 h, e.g. from 4 to 20 h, before starting the copolymerization of the monomers M.

In a preferred group of embodiments, the majority of the monomers M to be polymerized are fed to an aqueous solution of the carboxymethylcellulose under polymerization conditions. In this group of embodiments, in particular at least 70% by weight, especially at least 90% by weight, of the monomers M to be polymerized, based on the total amount of monomers M, are fed to an aqueous solution of the carboxymethylcellulose under polymerization conditions. Prior to the start of the feeding the monomers M, the concentration of the carboxymethylcellulose is preferabyl in the range from 5 to 30% by weight, in particular in the range from 10 to 20% by weight.

The term “polymerization conditions” is generally understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, polymerization temperature and polymerization pressure are selected such that a sufficient amount of initiating radicals is always present to initiate or to maintain the polymerization reaction.

In this preferred group of embodiments, the monomers M may by fed to the aqueous solution of the carboxymethylcellulose as a pure monomer mixture or as an aqueous emulsion of the monomers. Preference is given to feeding the monomers M as a pure monomer mixture.

In this context, the term “pure monomer mixture” means that the concentration of the monomers M is at least 99% by weight, based on the weight of the mixture.

In this preferred group of embodiments, the monomers M may be fed all at once to the aqueous solution of the carboxymethylcellulose under polymerization conditions. However, a portion or all of the monomers M, in particular the majority, i.e. at least 70% by weight, in particular at least 80% by weight, especially at least 90% by weight of the monomers M are fed to the polymerization mixture under polymerization conditions over an extended period of time, which may preferably last from 10 minutes to 5 h, in particular from 20 minutes to 4 h.

It is beneficial, when the aqueous solution of the carboxymethylcellulose is subjected to an oxidative treatment prior to the copolymerization of the monomers M. By the oxidative treatment, the carboxymethylcellulose is somewhat degraded which allows to keep the viscosity of the aquous solution in a range suitable for the polymerization.

The oxidative treatment can be carried out by treating the aqueous solution with a free-radical polymerization initiator (free-radical initiator) selected from the group of peroxides mentioned below. Peroxides used may, in principle, be inorganic peroxides, such as hydrogen peroxide or peroxodisulfates, such as the mono- or di-alkali metal or ammonium salts of peroxodisulfuric acid, with particular preference given to hydrogen peroxide. The oxidative pre-treatment is usually carried out at temperatures in the range from 30 to 170° C. Temperatures employed are frequently in the range from 40 to 140° C., in particular in the range from 50 to 120° C. and especially in the range from 60 to 110° C. Typically, the oxidiative pre-treatment is carried out immediately before starting the copolymerization of the monomers M.

According to the invention, the monomers M are copolmymerized by a radical copolymerization in water, in particular an emulsion copolymerization, in the presence of the required amount of carboxymethylcellulose. The conditions required for carrying out the radical copolymerization of the monomers M in water are sufficiently familiar to those skilled in the art, for example from the prior art cited at the outset and from “Emulsionspolymerisation” [Emulsion Polymerization] in Encyclopedia of Polymer Science and Engineering, vol. 8, pages 659 ff. (1987); D. C. Blackley, in High Polymer Latices, vol. 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer [Dispersions of Synthetic High Polymers], F. Hölscher, Springer-Verlag, Berlin (1969)]. These methods can be applied in a similar manner to the copolymerization of the monomers M in water in the presence of carboxymethylcellulose.

Preference is given to operation in the absence of oxygen, preferably in a stream of nitrogen. For the polymerization method any customary apparatus can be used, examples thereof including stirred tanks, stirred tank cascades, autoclaves and tubular reactors.

The radical copolymerization of the invention is usually conducted at temperatures in the range from 0 to 170° C. Temperatures employed are frequently in the range from 40 to 140° C., in particular in the range from 50 to 120° C. and especially in the range from 60 to 110° C.

The radical copolymerization is triggered by means of a free-radical polymerization initiator (free-radical initiator). These may, in principle, be peroxides or azo compounds and so-called redox initiator systems. Peroxides used may, in principle, be inorganic peroxides, such as hydrogen peroxide or peroxodisulfates, such as the mono- or di-alkali metal or ammonium salts of peroxodisulfuric acid, for example the mono- and disodium, -potassium or ammonium salts, or organic peroxides, such as alkyl hydroperoxides, for example tert-butyl hydroperoxide, p-menthyl hydroperoxide or cumyl hydroperoxide, and also dialkyl or diaryl peroxides, such as di-tert-butyl or dicumyl peroxide. Azo compounds used are essentially 2,2′-azobis(isobutyronitrile), 2,2′-azobis(2,4-dimethylvaleronitrile) and 2,2′ azobis(amidinopropyl) dihydrochloride (AlBA, corresponds to V-50 from Wako Chemicals). Preferably, the polymerization initiator comprises one or more inorganic peroxides. In partiuclar, the polymerization initiator comprises H₂O₂ and optionally one or more inorganic peroxides different therefrom, in particular a peroxodisulfate, such as the mono- or di-alkali metal or ammonium salts of peroxodisulfuric acid, for example the mono- and disodium, -potassium or ammonium salt of peroxodisulfuric acid.

Preferably, a redox initiator is used for initiating the radical copolymerization. Redox initiators usually comprise an oxidizing agent and a reducing agent or an oxidizing agent and a transition metal, which catalyzes the decomposition of the oxidizing agent. Said redox initiator is preferably water-soluble. Suitable oxidizing agents for redox initiator systems are essentially the peroxides specified above. Corresponding reducing agents, which may be used are sulfur compounds with a low oxidation state, such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, aldehyde sulfoxylates, in particular formaldehyde sulfoxylates, for example potassium and/or sodium formaldehyde sulfoxylate, ketone sulfoxylates, in particular bis(C₁-C₄-alkyl)-ketone sulfoxylates, such as acetone sulfoxylate and methylethylketone sulfoxylates and the respective salts thereof, in particular the alkalimetal salts thereof, alkali metal salts, specifically potassium and/or sodium salts of aliphatic sulfinic acids and alkali metal hydrogensulfites, for example potassium and/or sodium hydrogensulfite, ene diols, such as dihydroxymaleic acid, benzoin and/or ascorbic acid, and reducing saccharides, such as sorbose, glucose, fructose and/or dihydroxyacetone.

In particular, a redox initiator is used for initiating the radical copolymerization, which comprises H₂O₂ and optionally one or more inorganic peroxides different therefrom, in particular a peroxodisulfate, such as the mono- or di-alkali metal or ammonium salts of peroxodisulfuric acid, for example the mono- and disodium, -potassium or ammonium salt of peroxodisulfuric acid. More preferably, the redox initiator comprises at least one transition metal salt.

Suitable transition metals include, but are not limited to salts of iron, cobalt, cerium, nickel, copper, vanadium and manganese, in particular iron(II) salts, cobalt(II) salts, cerium(III) salts, cerium(IV) salts, nickel(II) salts and copper(I) salts. Preferred transition metal salts include, for example, iron(II) sulfate, iron(II) ammonium sulfate (Mohr’s salt), iron(II) phosphate, cobalt(II) chloride, cerium(III) nitrate, cerium(IV) sulfate, ammonium cerium(IV) sulfate, ammonium cerium(IV) nitrate, nickel(II) sulfate and copper(l) chloride and complexes of iron(II) salts, cobalt(II) salts, nickel(II) salts with a chelating agent such as ethylenediaminetetraacetic acid (EDTA), diethylenetriaminepentacetic acid (DPTA), methylglycinediacetic acid (MGDA) and N,N-bis(carboxymethyl)glutamic acid (GLDA).

The free-radical initiator is usually employed in an amount of 0.05 to 15% by weight, in particular in an amount from 0.1 to 10% by weight, especially in an amount from 0.2 to 8 wt%, based on the monomers M to be polymerized. In the case of a multicomponent initiator system (e.g., redox initiator systems), the weight figures above are based on the total sum of the components.

If the redox initiator comprises a transition metal salt, the transition metal salt is frequently used in an amount of 0.1 ppm to 1000 ppm, in particular from 1 ppm to 500 ppm, especially 2 ppm to 200 ppm, based on the weight of monomers M to be polymerized, or on monomers M to be polymerized in any one stage.

In a preferred embodiment, a radical polymerization initiator is used, which comprises or consists of a peroxide, which is in particular selected from the group consisting of H₂O₂ and peroxodisulfate and mixtures thereof, and a transition metal salt, in particular an iron(ll) salt, a cerium(III) salt or a cerium(IV) salt. Such combinations usually comprise from 0.5 to 10% of hydrogen peroxide and 0.1 ppm to 1000 ppm, in particular from 1 ppm to 500 ppm, especially 2 ppm to 200 ppm, of the transition metal salt, in each case based on the total amount of monomers M.

The copolymerization of the monomers M as defined above is effected in an aqueous medium in the presence of a carboxymethylcellulose, as defined above. The monomers M can be polymerized by the radical emulsion polymerization method, both in the feed procedure and in the batch procedure as described above. If the redox initiator comprises a transition metal salt, preferably an aqueous solution of the transition metal salt is initially charged to the aqueous solution of the carboxymethylcellulose, and the monomers are fed continuously or batch-wise to the polymerization reactor under polymerization conditions as described above.

The polymerization inititator may be charged all at once to the polymerization reactor before starting the polymerization. Preferably, at least a portion of the polymerization reactor is fed to the polymerization reactor under polymerization conditions. It is also possible that a portion of the polymerization initiator is charged to the polymerization reactor before the polymerization is started and then the remainder of the polymerization initiator is feed in portions or continuously to the polymerization reaction under polymerization conditions. If a redox initiator is used, it is possible that both components of the redox initiator may be charged or fed separately or as a mixture to the polymerization reactor. It is also possible that one part of the redox initiator, e.g. the oxidizing part, is charged to the polymerization reaction all at once or in portions, while the other part, e.g. the reducing part, is fed to the polymerization reaction under polymerization reactions. It is also possible that a portion of the redox initiator, e.g. a portion of the oxidzing part, is charged to the polymerization reactor before starting the polymerization reaction and then the remainder is of the oxidizing part and the reducing part are fed seperately or as a mixture to the polymerization reaction under polymerization conditions.

In particular, a portion of the redox initiator, e.g. a portion of the oxidzing part, is added to the aqueous solution of the carboxymethylcellulose, which may also contain a transition metal salt, before establishing polymerization conditions. Then, polymerization conditions are established followed by starting with feeding the monomers M to the polymerization reaction and feeding the remainder of the redox initiator in parallel to the polymerization reaction, e.g. in portions or continuously. For example, a portion of H₂O₂ is added to the aqueous solution of the carboxymethylcellulose, which may also contain a transition metal salt before establishing polymerization conditions. Then, polymerzation conditions are established followed by the addition of a portion of further oxidizing parts, e.g. a peroxidsulfate and starting with feeding the monomers M to the polymerization reaction followed by starting with feeding of the reducing part and optionally the remainder of the oxidizing part.

Preferably, the monomers M are polymerized in the presence of at least one emulsifier as described above. The emulsifier will remain in the aqueous polymer composition. Thus, the type of emulsifier will be the same as described above. The amount of emulsifier is typically in the range from 0.1 to 5% by weight, in particular in an amount of 0.3 to 4% by weight and especially in an amount of 0.5 to 3% by weight, based on the total weight of monomers M. With regard to preferred emulsifiers, reference is made to the above.

The polymerization is usually carried out in the absence of oxygen, preferably in an inert gas atmosphere, for example under nitrogen. During the polymerization, thorough mixing of the components should be ensured. Thus, the reaction mixture is preferably stirred for the entire duration of the polymerization and of any subsequent postpolymerization.

The polymerization is usually carried out at a pH of from 2 to 9, preferably in the weakly acidic range at a pH of from 3 to 5.5. The pH can be adjusted to the desired value before or during the polymerization using conventional acids, such as hydrochloric acid, sulfuric acid or acetic acid, or using bases, such as sodium hydroxide solution, potassium hydroxide solution, ammonia, ammonium carbonate, etc. The dispersions are preferably adjusted to a pH of from 5 to 7 with sodium hydroxide solution, potassium hydroxide solution or ammonia after the end of the polymerization.

In order to remove the remaining monomers from the polymer dispersions as substantially as possible, a postpolymerization is expediently carried out. This postpolymerization is typically called chemical desodorization. For this purpose, an initiator from the group consisting of hydrogen peroxide, peroxides, hydroperoxides and/or azo initiators is added to the polymer dispersions after the end of the main polymerization. The combination of the initiators with suitable reducing agents, such as, for example, ascorbic acid or sodium bisulfite, is also possible. Oil-soluble initiators, which are sparingly soluble in water may also be used, for example conventional organic peroxides, such as dibenzoyl peroxide, di-tert-butyl peroxide, tert-butyl hydroperoxide, cumyl hydroperoxide or biscyclohexyl peroxydicarbonate.

For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. Hydrogen hydroperoxide is preferably used for the postpolymerization. The postpolymerization is carried out, for example, in a temperature range from 35 to 100° C., preferably from 45 to 95° C.

Instead or after postpolymerization, the aqueous polymer composition may be subjected to a stripping or distillation procedure to further removing non-reacted monomers, which is also called physical desodoration.

After the end of the polymerization, a complexing agent for heavy metal ions can be added to the aqueous polymer compositions in an amount, such that all heavy metal ions are bound in complexed form.

After the end of the polymerization, the aqueous polymer compositions may be confectionated, e.g. by addition of a biocide in order to avoid microbial spoiling.

Another aspect of the present invention is a laundry detergent composition comprising an aqueous polymer composition of the present invention. In the laundry detergent composition according to the present invention, the copolymer of the present invention is usually present in the amount of from 0.1 to 20% by weight, in particular in an amount of from 0.2 to 10% by weight and especially in an amount of from 0.3 to 5% by weight, calculated as the total amount of polymer solids in the aqueous polymer composition of the invention.

The aqueous polymer compositions are particularly suitable for liquid or gel-type laundry compositions. However, they can also be incorporated into solid laundry detergent compositions. In the latter case, the water will typically be removed partially or completely before or during production of the solid laundry detergent composition, for example by spray-drying, for example with the help of a spray nozzle.

In a preferred embodiment, said laundry detergent composition is liquid or gel-type. Liquid in accordance with the present invention means a viscosity of less than 500 mPas at room temperature, and gel-like in accordance with the present invention means viscous but still pourable, i.e. a viscosity of less than 10,000 mPas at room temperature, preferably a viscosity between 500 and 10,000 mPas at room temperature.

The viscosity can be determined with Brookfield according to DIN ISO 2555:2000-01 (LVT spindle, RT). Gel-type laundry detergent formulations include pourable gel-type formulations and in particular pre-dosed laundry detergent formulations, where the gel-type detergent formulation is enclosed in a chamber formed by a water-soluble polymer sheet.

In addition to the copolymer of the aqueous polymer composition of the present invention, hereinafter component (A), the laundry detergent composition typically comprises at least one surfactant as component (B) and optionally at least one builder as component (C).

The surfactant include anionic surfactants, nonionic surfactants, cationic surfactants, amphoteric surfactants and zwitterionic surfactants and mixtures thereof. Surfactant ingredients suitable for laundry detergent compositions are common general knowledge. Detailed descriptions can be found for example in WO 99/06524 and WO 99/04313 and US 2008/0248987 and Liquid Detergents, Editor: Kuo-Yann Lai, Surfactant Sci. Ser., Vol. 67, Marcel Decker, New York, 1997, p. 272-304.

Suitable nonionic surfactants are in particular:
alkoxylated C₈-C₂₂-alcohols, such as fatty alcohol alkoxylates, oxoalcohol alkoxylates and Guerbet alcohol alkoxylates: the alkoxylation can be effected with C₂-C₂₀ alkylene oxides, preferably ethylene oxide, propylene oxide and/or butylene oxide. Block copolymers or random copolymers may be present. Per mole of alcohol, they comprise typically from 2 to 50 mol, preferably from 3 to 20 mol of at least one alkylene oxide. The preferred alkylene oxide is ethylene oxide. The alcohols have preferably from 10 to 18 carbon atoms;
alkyl phenol alkoxylates, especially alkylphenol ethoxylates, which comprise C₆-C₁₄-alkyl chains and from 5 to 30 mol of alkylene oxide/mole;
alkylpolyglucosides, which comprise C₈-C₂₂-alkyl, preferably C₁₀-C₁₈-alkyl chains and generally from 1 to 20, preferably from 1.1 to 5 glucoside units;
N-alkylglucamides, fatty acid amide alkoxylates, fatty acid alkanolamide alkoxylates and block copolymers of ethylene oxide, propylene oxide and/or butylene oxide.

Suitable anionic surfactants are, for example:
sulfates of (fatty) alcohols having from 8 to 22, preferably from 10 to 18 carbon atoms, especially C₉C₁₁-alcohol sulfates, C₁₂C₁₄-alcohol sulfates, C₁₂-C₁₈-alcohol sulfates, lauryl sulfate, cetyl sulfate, myristyl sulfate, palmityl sulfate, stearyl sulfate and tallow fat alcohol sulfate;
sulfated alkoxylated C₈-C₂₂-alcohols (alkyl ether sulfates): compounds of this type are prepared, for example, by first alkoxylating a C₈-C₂₂-alcohol, preferably a C₁₀-C₁₈-alcohol, for example a fatty alcohol, and then sulfating the alkoxylation product. For the alkoxylation, preference is given to using ethylene oxide;
linear C₈-C₂₀ alkylbenzenesulfonates (LAS), preferably linear C₉-C₁₃-alkylbenzenesulfonates and -alkyltoluenesulfonates;
alkanesulfonates, especially C₈-C₂₄-alkanesulfonates, preferably C₁₀-C₁₈-alkanesulfonates;
fatty acid ester sulfonates of the formula R¹CH(SO₃M)CO₂R² in which R¹ is C₆-C₂₀-alkyl, preferably C₈-C₁₆-alkyl, and R² is C₁-C₄-alkyl, preferably methyl or ethyl, and M is hydrogen, a water-soluble cation, for example alkali metal cation or ammonium ion;
olefinsulfonates having from 8 to 22, preferably from 12 to 18, carbon atoms;
isethionates, especially acyl isethionates and N-acyl taurates;
N-acyl sarcosinates;
sulfosuccinates (mono- or diesters of sulfosuccinic acid) and alkyl succinates;
organic phosphate esters, especially mixtures of mono- and diester phosphates of hydroxyl-terminated alkoxide condensates and salts thereof. These include polyoxalkylated alkylarylphosphate esters, for example based on alkoxylated C₈-C₂₂-alcohols or alkoxylated phenol derivatives;
soaps, such as the sodium and potassium salts of C₈-C₂₄-carboxylic acids.

In the laundry detergent, the anionic surfactants are preferably present in the form of their salts. Suitable salts are, for example, alkali metal salts, such as sodium, potassium and lithium salts, and ammonium salts, such as hydroxyethylammonium, di(hydroxyethyl) ammonium and tri(hydroxyethyl)ammonium salts.

Particularly suitable cationic surfactants include:
C₇-C₂₅ alkylamines;
N,N-dimethyl-N-(C₇-C₂₅-hydroxyalkyl)ammonium salts;
mono- and di(C₇-C₂₅-alkyl)dimethylammonium compounds quaternized with alkylating agents;
ester quats, especially quaternary esterified mono-, di- and trialkanolamines, which have been esterified with C₈-C₂₂-carboxylic acids;
imidazoline quats.

Suitable amphoteric surfactants are derivatives of aliphatic or heterocyclic, secondary and tertiary amines in which the aliphatic radicals preferably have from 8 to 18 carbon atoms, and at least one radical comprises one or more anionic water-soluble groups, for example one or more carboxylate, sulfonate, sulfate, phosphate or phosphonate groups. Examples of suitable amphoteric surfactants are:
3-(alkylamino)propionates, (alkylamino)acetates, 3-(dialkylamino)propionates and (dialkylamino) acetates, where preferably at least one alkyl group comprises from 8 to 18 carbon atoms.
3-[(3-alkylaminopropyl)amino]propionates and [(3-alkylaminopropyl)amino]acetates, where the alkyl group preferably comprises from 8 to 18 carbon atoms.
[(2-acylaminoethyl)(2-hydroxyethyl)amino]acetates, where the acyl group preferably comprises from 8 to 18 carbon atoms.
(alkylamino)propanesulfonates, where the alkyl group preferably comprises from 8 to 18 carbon atoms.

Suitable zwitterionic surfactants are, for example:
amine oxides, especially alkyldimethylamine oxides and alkyldiethylamine oxides, where the alkyl group preferably comprises from 8 to 18 carbon atoms;
betaines, especially carbobetaines, sulfobetaines and phosphobetaines, such as: R⁶(R⁷)₂N⁺(CH₂)ₙCOO- with the following preferred definition of the variables: R⁶: C₈-C₁₈-alkyl; R⁷: C₁-C₃-alkyl; n: from 1 to 5; R⁶CONH(CH₂)ₘ(R⁷)₂N⁺(CH₂)ₙCOO- with the following preferred definition of the variables: R⁶: C₇-C₁₇-alkyl; R⁷: C₁-C₃-alkyl; n, m: each independently from 1 to 5; R⁶(R⁷)₂N⁺(CH₂)ₙSO₃- with the following preferred definition of the variables: R⁶: C₈-C₁₈-alkyl; R⁷: C₁-C₃-alkyl; n: from 1 to 5;
cocoamidopropylbetaine.

Detailed descriptions of amphoteric and zwitterionic surfactants can also be found in EP-A-851 023 and also in Die Tenside [The surfactants], Carl Hanser Verlag, 1993.

Laundry detergent compositions according to the invention may comprise at least one builder (C). In the context of the present invention, no distinction will be made between builders and such components, elsewhere called “co-builders”. Examples of builders (C) are complexing agents, hereinafter also referred to as complexing agents (C1), ion exchange compounds and precipitating agents (C2). Builders are selected from citrate, phosphates, silicates, carbonates, phosphonates, amino carboxylates and polycarboxylates.

Examples of complexing agents (C1) (“sequestrants”) include, but are not limited to citrate, phosphates, phosphonates, silicates and ethylene amine derivatives, such as ethylene diamine tetraacetate, diethylene pentamine pentaacetate, methylglycine diacetate and glutamine diacetate. Complexing agents (C1) will be described in more details below.

Examples of precipitating agents (C2) are sodium carbonate and potassium carbonate.

In the context of the present invention, the term citrate includes the mono- and the dial-kali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates, such as sodium tripolyphosphate. Preferably, however, the composition according to the invention is free from phosphates and polyphosphates with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na₂CO₃.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylenediaminetetramethy-lenephosphonate (EDTMP), diethylenetriaminepentamethylenphosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaace-tate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts, such as the sodium salts, in particular of the respective fully neutralized compound.

Silicates in the context of the present invention include in particular sodium disilicate and sodium metasilicate, alumosilicates, such as, for example, zeolites and sheet silicates, in particular those of the formula a-Na₂Si₂O₅, P-Na₂Si₂O₅, and 6-Na₂Si₂O₅.

Laundry detergent compositions according to the invention may contain one or more builder selected from materials not being mentioned above. Examples of builders are a-hydroxypropionic acid and oxidized starch.

In one embodiment of the present invention, builder (C1) comprise one or more polycarboxylates. The term “polycarboxylates” includes non-polymeric polycarboxylates, oligomeric and polymeric polycarboxylates.

Non-polymeric polycarboxylates include, but are not limited to succinic acid, C₂-C₁₆-alkyl disuccinates, C₂-C₁₆-alkenyl disuccinates, ethylene diamine N,N′-disuccinic acid, tartaric acid diacetate, alkali metal malonates, tartaric acid monoacetate, propanetricar-boxylic acid, butanetetracarboxylic acid and cyclopentanetetracarboxylic acid.

Oligomeric or polymeric polycarboxylates are, for example, polyaspartic acid, polyacrylic acid and polymethacrylic acid their alkali metal salts.

Suitable polymeric polycarboxylates are in particular polyacrylic acids (or their alkali metal salts), which preferably have an average molecular weight Mw in the range of from 1,000 to 40,000 g/mol, more preferably 1,000 to 10,000 g/mol, in particular 1,000 to 8,000 g/mol. The molecular weights refer to the weight average molecular weight as determined by size exclusion chromatography of a 0.2 g/L solution of the polymer in tetrahydrofurane containing 0.1% by weight of trifluoroacetic acid at 35° C. Also of suitability are copolymers of acrylic acid with methacrylic acid and copolymers of acrylic acid and/or methacrylic acid with at least one monomer from the group consisting of monoethylenically unsaturated C₄-C₁₀-dicarboxylic acids or anhydrides thereof, such as maleic acid, maleic anhydride, fumaric acid, itaconic acid and citraconic acid.

Polycarboxylates, which are suitable as binders also include copolymers of at least one monomer from the group consisting of monoethylenically unsaturated Cs-Cs-monocarboxylic acids and monoethylenically unsaturated C₄-C_{w}-dicarboxylic acids or anhydrides thereof, such as acrylic acid, methacrylic acid, maleic acid, maleic anhydride, fumaric acid, itaconic acid and citraconic acid, with at least one hydrophilic or hydrophobic monomer as listed below.

Suitable hydrophobic monomers are, for example, isobutene, diisobutene, butene, pen-tene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are in particular monomers with sulfonate or phosphonate groups and also nonionic monomers with hydroxyl function or alkylene oxide groups. The following monomers serve as example: allyl alcohol and its alkoxylates, isoprenol and its alkoxylates, methoxypolyethylene glycol (meth)acrylate, methoxypoly-propylene glycol (meth)acrylate, methoxypolybutylene glycol (meth)acrylate, methoxy-polypropylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacryl-amido-2-hydroxypropanesulfonic acid, allylsulfonic acid, methallylsulfonic acid, allyl-oxybenzenesulfonic acid, methallyloxybenzenesulfonic acid, 2-hydroxy-3-(2-pro-penyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Laundry detergent compositions according to the invention can comprise, for example, in the range from in total 0.1 to 70% by weight, preferably 10 to 50% by weight, preferably up to 20% by weight, of builder(s) (C), especially in the case of solid formulations. Liquid formulations according to the invention preferably comprise in the range of from 0.1 to 8% by weight of builder (C).

In one embodiment of the present invention, the use according to the invention comprises the use of modified polysaccharide of the present invention (A) together with at least one enzyme (D), which are known to be useful in laundry detergent formulations. Useful enzymes are, for example, one or more lipases, hydrolases, amylases, proteases, cellulases, hemicellulases, phospholipases, esterases, pectinases, lactases, mannanases and peroxidases, and combinations of at least two of the foregoing types of the foregoing.

Enzyme (D) can be incorporated at levels sufficient to provide an effective amount for cleaning. The preferred amount is usually in the range from 0.001% to 5% of active enzyme by weight in the detergent composition according to the invention. Together with enzymes also enzyme stabilizing systems may be used, such as, for example, calcium ions, boric acid, boronic acids, such as 4-FPBA (4-formylphenylboronic acid) propylene glycol, short chain carboxylic acids and short chain peptides. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH₂)₃COOH, adipic acid and mixtures from at least two of the foregoing, as well as the respective sodium and potassium salts.

Laundry detergent compositions according to the invention can comprise one or more alkali carriers. Alkali carriers ensure, for example, a pH of at least 9 if an alkaline pH is desired. Suitable alkali carriers are, for example, the alkali metal carbonates, the alkali metal hydrogen carbonates and alkali metal metasilicates mentioned above, and, additionally, alkali metal hydroxides. A preferred alkali metal is in each case potassium, particular preference being given to sodium.

Another component of liquid laundry detergent compositions according to the invention that may be present, if desired, is a hydrotrope. Preferred hydrotropes comprise the sulfonated hydrotropes, for example, the alkylarylsulfonates or alkylarylsulfonic acids. The preferred hydrotropes are selected from xylene, toluene sulfonate or -sulfonic acid, cumene sulfonate or -sulfonic acid, naphthalene-sulfonate or -sulfonic acid and mixtures thereof. Counterions are preferably selected from sodium, calcium and ammonium. If necessary, the liquid laundry detergent compositions according to the invention may contain up to 20% by weight of a hydrotrope, in particular 0.05 to 10% by weight, based on the total weight of the liquid laundry detergent composition.

Liquid laundry detergent compositions according to the invention may further comprise alkoxylated polyalkylenepolyamines, which can be obtained by reacting alkylene oxides with polyalkylenepolyamines. Preferably, the liquid laundry detergent composition will comprise 0.1 to 10% by weight, based on the total weight of the liquid laundry detergent composition, of alkoxylated polyalkylenepolyamines. In a preferred embodiment, the alkoxylated polyalkylenepolyamines are alkoxylated polyethyleneimines. Polyethyleneimines are currently obtained by the homopolymerization of ethyleneimine. Ethyleneimine is a highly reactive, corrosive and toxic intermediate, which can be synthesized in different ways (aziridines, Ulrich Steuerle, Robert Feuerhake; in Ullmann’s Encyclopedia of Industrial Chemistry, 2006, Wiley-VCH, Weinheim). Alkoxylated polyalkylenepolyamines can be prepared as described in WO 2013/076024.

Liquid and gel-type laundry detergent compositions according to the invention will usually contain water in amounts up to approx. 80% by weight, in particular in the range from 20 to 80% by weight, and especially in the range from 30 to 70% by weight, based on the total weight of the liquid or gel-type laundry detergent composition. The water may, if desired, also be replaced partially by a water-soluble solvent component. Non-aqueous solvents that may be used in the liquid laundry detergent compositions originate from the group of monovalent or polyvalent alcohols, alkanolamines or glycol ethers, for example, if they are miscible with water in the concentration range indicated. The solvents are preferably selected from ethanol, n-propanol or isopropanol, the buta-nols, ethylene glycol, butanediol, glycerol, diethylene glycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or ethyl ether, diisopropylene glycol monomethyl or ethyl ether, methoxy, ethoxy or butoxytriglycol, 1-butoxyethoxy-2-propanol, 3-methyl-3-methoxybutanol, propyl-ene glycol tert-butyl ether and mixtures thereof. The amount of non-aqueous water-soluble solvent component, based on the total amount of the composition, is preferably up to 15% by weight, in particular 0.5 to 10% by weight, based on the total weight of the liquid laundry detergent composition.

Further optional ingredients of laundry detergent compositions are viscosity modifiers, cationic surfactants, foam boosting or foam reducing agents, perfumes, dyes, optical brighteners, thickeners, solubilizers, dye transfer inhibiting agents, pH modifiers, perfume carriers, optical brighteners, shrink inhibitors, grease inhibitors, active antimicrobial ingredients, antioxidants, antistats, ironing aids, hydrophobizing and impregnating agents, swell and antislip agents and UV absorbers.

A further aspect of the present invention is the use of the aqueous polymer compositions of the present invention for increasing the whiteness of a washed fabric, the use of the aqueous polymer compositions of the present invention as anti-greying agent in aqueous laundry processes, the use of the aqueous polymer compositions in the manufacture of a liquid laundry detergent composition.

Another aspect of the present invention is a method for increasing the whiteness of a washed fabric comprising the step of applying the aqueous polymer composition of the present invention in an aqueous laundry process, either as a combination of the aqueous polymer composition with a laundry composition or incorporated in a liquid laundry detergent composition. The present invention further relates to a method of reducing greying in aqueous laundry processes comprising the step of applying the aqueous polymer composition of the present invention in an aqueous laundry process, either as a combination of the aqueous polymer composition with a laundry composition or incorporated in a liquid laundry detergent composition. The present invention also relates to a method of manufacturing a liquid laundry detergent composition comprising mixing the aqueous polymer composition of the present invention in an effective amount with components (B) and (C) as defined above and, optionally, further components are being mixed together in the presence of water. The order of addition of the various ingredients is not critical, but it is preferred to add the detergent(s) first and to add the enzyme(s), if desired, as last component. Mixing can be accomplished, for example, by agitating or stirring. Said agitating or stirring can be performed until a clear solution or a homogeneous-looking dispersion has formed.

The term “effective amount” means an amount of the aqueous polymer composition that is sufficient to increase the whiteness of a washed fabric, to reduce greying in aqueous laundry processes or to modify the rheology of a homecare composition.

The use of the aqueous polymer compositions according to the invention in an aqueous laundry process can deal with any type of laundry and with any type of fibers. Fibers can be of natural or synthetic origin, or they can be mixtures of natural of natural and synthetic fibers. Examples of fibers of natural origin are cotton and wool. Examples for fibers of synthetic origin are polyurethane fibers such as Spandex@ or Lycra@, polyester fibers, or polyamide fibers. Fibers may be single fibers or parts of textiles such as knitwear, wovens, or nonwovens.

It is preferred to use the aqueous polymer compositions of the present invention in an aqueous laundry process at a temperature in the range of from 15 to 90° C., preferably in the range of from 20 to 60° C.

The use in an aqueous laundry process according to the invention can be performed manually, but it is preferred to apply the aqueous polymer composition of the present invention (A) in a mechanical aqueous laundry process, for example in a washing machine.

### EXAMPLES

The following abbreviations are used:

| | |
|---|---|
| CMC | Carboxymethylcellulose |
| Comp. | composition |
| Δ R (%) | Delta reflectance in % vs. standard |
| DS | Degree of substitution |
| EDTA | Ethylenediamine N,N,N′,N′-tetraacetic acid. |
| EO | oxyethylene (CH₂CH₂O) |
| Ex. | Example |
| Fe-Kat | EDTA-Fe(lll) pottassium salt |
| SEC | Size Exclusion Chromatography |
| SDS | sodium dodecyl sulfate |
| NaPS | Sodium peroxodisulfate |
| H₂O₂ | Hydrogenperoxide |
| % b.w. | % by weight |
| pphm | parts by weight per 100 parts of monomers |
| rpm | rotation per minute |
| SC | Solids content |
| n.d. | not determined |

### Analytics

CMC types have been characterized by the Brookfield viscosity of their 2% b.w. aqueous solutions, by their molecular weight and by their degree of substitution.
Brookfield viscosity of CMC was determined by a conventional Brookfield viscometer using a 2% b.w. aqueous solution of the respective CMC in deionized water at 20° C. (spindle 5 at 20 rpm).
Molecular weight of CMC types was determined by field flow fractionation of a 0.5% by weight solution of the CMC in a 0.1 M solution of NaNOs in deionized water at 25° C.
Molecular weight of the copolymers was determined by SEC of a 0.2 g/L solution of the respective copolymer in tetrahydrofurane containing 0.1% by weight of trifluoroacetic acid at 35° C. and an elution rate of 1 mL/min using for calibration polystyrene standards having molecular weights of M = 580 to M 6.870.000.
Degree of substitution was determined according to the monograph about carboxymethylcellulose, resolution OIV/OENO 366/2009, method 5.17.

If not stated otherwise, viscosities of the polymer dispersions were determined as Brookfield viscosities determined according to DIN ISO 2555:2018-09 at 25° C. at pH 4.5 - 5.0 and rotational speed of 20 rotations per minute using spindle RT3.

The solids content was determined by drying a defined amount of the aqueous polymer dispersion (about 2 g) to constant weight in an aluminum crucible having an internal diameter of about 5 cm at 130° C. in a drying cabinet (2 hours). Two separate measurements were conducted. The value reported in the example is the mean of the two measurements.

If not stated otherwise, pH values of the polymer dispersions were measured according to the standard method DIN EN 1262:2004-01.

Particle size distribution of the polymers in the aqueous polymer composition can be determined by dynamic light scattering (also termed quasi-elastic light scattering) of an aqueous polymer dispersion diluted with deionized water to 0.001 to 0.5% by weight at 22° C. by means of a HPPS from Malvern Instruments, England. What is reported is the cumulant Z average diameter calculated from the measured autocorrelation function (ISO Standard 13321). The polydispersity index can be calculated from a simple 2 parameter fit to the correlation data (the cumulants analysis).

### Starting Materials

CMC1: A commercial carboxymethylcellulose-sodium salt having a degree of substitution of 0.75, a weight average molecular weight MW of about 100.000-120.000 Dalton, further characterized by a Brookfield viscosity of 40 mPas.

CMC2: A commercial carboxymethylcellulose-sodium salt having a degree of substitution of about 0.7-0.9, a weight average molecular weight MW of about 500.000 Dalton, further characterized by a Brookfield viscosity of 760 mPas.

CMC80: A commercial carboxymethylcellulose-sodium salt having a degree of substitution of about 0.7-0.9, further characterized by a Brookfield viscosity of 80 mPas.

CMC150: A commercial carboxymethylcellulose-sodium salt having a degree of substitution of about 0.7-0.9, further characterized by a Brookfield viscosity of 150 mPas.

Emulsifier 1: A 15% b.w. aqueous solution of SDS.

Emulsifier 2: A 45% b.w. aqueous solution of the dodecyl diphenylether disulfonate sodium salt.

Emulsifier 3: Mixture of 60% b.w. C₁₆-C₁₈-alkyl-(EO)₂₅-methacrylate, 20% methacrylic acid and 20% b.w. water.

In the following experiments the reactants were used as such, if not stated otherwise. Fe-Kat was used as a 1% by weight aqueous solution.

Initiator solution 1: 30% b.w. aqueous solution of H₂O₂.

Initiator solution 2: 7% b.w. aqueous solution of NAPS.

Co-initiator solution: 0.1% by weight aqueous solution of ascorbic acid.

Biocide: Commercial 5% b.w. aqueous solution of a mixture of 2-methylisothiazolinone and benzisothiazolinone.

### Synthesis of the Aqueous Polymer Composition of the Invention

### Example 1 (400 Ppm CMC1, Monomer Feed as Emulsion)

A reaction vessel equipped with a stirrer, nitrogen inlet and means for controlling the temperatures was charged with 1700 g of deionized water, 0.16 g of the aqueous solution of the Fe-Kat and 320 g of CMC1. The resulting viscous solution was stirred for 12 h at 22° C. The concentration of CMC in the aqueous solution was 15.7% b.w. Then, 13.3 g of initiator solution 1 were added, followed by heating of the resulting mixture to 85° C. with stirring. The viscosity of the obtained solution determined according to Brookfield at 85° C. using RVT spindle 6 at 10 rpm was 10100 mPas. Then, 1.14 g of the initiator solution 2 was added, followed by starting the addition of the monomer emulsion, while continuing stirring at maintaining the temperature at 85° C. The monomer emulsion consisted of 66.62 g of water, 28.0 g (35 pphm) of ethyl acrylate, 40.0 g (50 pphm) of methyl methacrylate, 12.0 g (15 pphm) of methacrylic acid, 1.33 g of emulsifier 1 and 0.44 g of emulsifier 2. Within 90 min., the monomer emulsion was metered into the reaction vessel. 15 min. after having started the addition of the monomer emulsion, 0.27 g of initiator solution 1 were rapidly added, followed by metering 16 g of the co-initiator solution into the reaction vessel within 105 min., while keeping the temperature at 85° C.

### Desodoration

After the addition of the co-initiator solution had been completed, 0.27 g of initiator solution 1 were rapidly added, followed by metering 16 g of the co-initiator solution into the reaction vessel within 90 min., while keeping the temperature at 85° C. After having completed the addition of the co-initiator solution, the pressure in the reaction vessel was lowered to 700 mbar and unreacted ethyl acylate was removed by passing a stream of nitrogen through the reaction mixture.

### Finishing

Then, the reaction mixture was cooled to 22° C., followed by addition of 0.43 g of the biocide solution and filtering the reaction mixture through a nylon mesh. Thereby 2200 g of an aqueous polymer dispersion having a solids content of 16.9% by weight, a pH of 4.9 and a viscosity of 557 mPas were obtained.

### Example 2 (400 Ppm CMC1, Monomer Feed as Mixture)

A reaction vessel equipped with a stirrer, nitrogen inlet and means for controlling the temperatures was charged with 1344 g of deionized water, 0.12 g of the aqueous solution of the Fe-Kat, 1.0 g of emulsifier 1 and 0.33 g of emulsifier 2. Then, 340 g of CMC1 were added with stirring to obtain a viscous solution, which was stirred for 12 h at 22° C. The concentration of CMC in the aqueous solution was 15.7% b.w. Then, 10.0 g (5 pphm) of initiator solution 1 were added, followed by heating of the resulting mixture to 85° C. with stirring. The viscosity of the obtained solution determined according to Brookfield at 85° C. using RVT spindle 6 at 10 rpm was 10100 mPas.

Then, 0.86 g of the initiator solution 2 was added, followed by starting the addition of the monomer mixture, while continuing stirring at maintaining the temperature at 85° C. The monomer mixture consisted of 21.0 g (35 pphm) of ethyl acrylate, 30.0 g (50 pphm) of methyl methacrylate and 9.0 g (15 pphm) of methacrylic acid. Within 90 min., the monomer mixture was metered into the reaction vessel. 15 min. after having started the addition of the monomer emulsion, 0.25 g of initiator solution 1 were rapidly added, followed by metering 12 g of the co-initiator solution into the reaction vessel within 105 min., while keeping the temperature at 85° C.

### Desodoration

After the addition of the co-initiator solution had been completed, 0.24 g of initiator solution 1 were rapidly added, followed by metering 12 g of the co-initiator solution into the reaction vessel within 90 min., while keeping the temperature at 85° C. After having completed the addition of the co-initiator solution, the pressure in the reaction vessel was lowered to 700 mbar, and unreacted ethyl acylate was removed by passing a stream of nitrogen through the reaction mixture.

### Finishing

Then, the reaction mixture was cooled to 22° C., followed by addition of 0.32 g of the biocide solution and filtering the reaction mixture through a nylon mesh. Thereby 1700 g of an aqueous polymer dispersion having a solids content of 19.5% by weight, a pH of 4.8 and a viscosity of 320 mPas were obtained.

### Example 3 (200 Ppm CMC1, Monomer Feed as Mixture)

A reaction vessel equipped with a stirrer, nitrogen inlet and means for controlling the temperatures was charged with 1160 g of deionized water, 0.20 g of the aqueous solution of the Fe-Kat, 1.67 g of emulsifier 1 and 0.56 g of emulsifier 2. Then, 200 g of CMC1 were added with stirring to obtain a viscous solution, which was stirred for 12 h at 22° C. The concentration of CMC in the aqueous solution was 14.5% b.w. Then, 16.6 g (5 pphm) of initiator solution 1 were added, followed by heating of the resulting mixture to 85° C. with stirring. The viscosity of the obtained solution determined according to Brookfield at 85° C. using RVT spindle 6 at 10 rpm was 8000 mPas.

Then, 1.43 g of the initiator solution 2 was added, followed by starting the addition of the monomer mixture, while continuing stirring at maintaining the temperature at 85° C. The monomer mixture consisted of 35.0 g (35 pphm) of ethyl acrylate, 50.0 g (50 pphm) of methyl methacrylate and 15.0 g (15 pphm) of methacrylic acid. Within 120 min. the monomer mixture was metered into the reaction vessel. 15 min. after having started the addition of the monomer emulsion, 0.40 g of initiator solution 2 were rapidly added, followed by metering 12 g of the co-initiator solution into the reaction vessel within 135 min., while keeping the temperature at 85° C.

### Desodoration

After the addition of the co-initiator solution had been completed, 0.40 g of initiator solution 1 were rapidly added, followed by metering 20 g of the co-initiator solution into the reaction vessel within 120 min., while keeping the temperature at 85° C. After having completed the addition of the co-initiator solution, the pressure in the reaction vessel was lowered to 700 mbar, and unreacted ethyl acylate was removed by passing a stream of nitrogen through the reaction mixture.

### Finishing

Then, the reaction mixture was cooled to 22° C., followed by addition of 0.54 g of the biocide solution and filtering the reaction mixture through a nylon mesh. Thereby 1650 g of an aqueous polymer dispersion having a solids content of 21.1% by weight, a pH of 4.7 and a viscosity of 105 mPas were obtained.

### Example 4 (150 Ppm CMC1, Monomer Feed as Mixture)

A reaction vessel equipped with a stirrer, nitrogen inlet and means for controlling the temperatures was charged with 1076 g of deionized water, 0.24 g of the aqueous solution of the Fe-Kat, 2.00 g of emulsifier 1 and 0.67 g of emulsifier 2. Then, 180 g of CMC1 were added with stirring to obtain a viscous solution, which was stirred for 12 h at 22° C. The concentration of CMC in the aqueous solution was 14.0% b.w. Then, 15.0 g (3.75 pphm) of initiator solution 1 were added, followed by heating of the resulting mixture to 85° C. with stirring. The viscosity of the obtained solution determined according to Brookfield at 85° C. using RVT spindle 6 at 10 rpm was 7000 mPas.

Then, 1.71 g of the initiator solution 2 was added, followed by starting the addition of the monomer mixture, while continuing stirring at maintaining the temperature at 85° C. The monomer mixture consisted of 42.0 g (35 pphm) of ethyl acrylate, 60.0 g (50 pphm) of methyl methacrylate and 18.0 g (15 pphm) of methacrylic acid. Within 120 min. the monomer mixture was metered into the reaction vessel. 15 min. after having started the addition of the monomer emulsion, 0.48 g of initiator solution 2 were rapidly added, followed by metering 24 g of the co-initiator solution into the reaction vessel within 135 min., while keeping the temperature at 85° C.

### Desodoration

After the addition of the co-initiator solution had been completed, 0.48 g of initiator solution 1 were rapidly added, followed by metering 24 g of the co-initiator solution into the reaction vessel within 120 min., while keeping the temperature at 85° C. After having completed the addition of the co-initiator solution, the pressure in the reaction vessel was lowered to 700 mbar and unreacted ethyl acylate was removed by passing a stream of nitrogen through the reaction mixture.

### Finishing

Then, the reaction mixture was cooled to 22° C., followed by addition of 0.65 g of the biocide solution and filtering the reaction mixture through a nylon mesh. Thereby 1650 g of an aqueous polymer dispersion having a solids content of 23.4% by weight, a pH of 4.6 and a viscosity of 105 mPas were obtained.

### Example 5 (150 Ppm CMC1, Monomer Feed as Mixture)

The polymerization, desodoration and finishing were carried out as described for example 4, except for using the following monomer mixture: 24.0 g (20 pphm) of ethyl acrylate, 23.0 g (15 pphm) of butyl acrylate, 60.0 g (50 pphm) of methyl methacrylate and 18.0 g (15 pphm) of methacrylic acid. Thereby 1650 g of an aqueous polymer dispersion having a solids content of 22.4% by weight a pH of 4.7 and a viscosity of 101 mPas were obtained.

### Example 6 (400 Ppm CMC1, Monomer Feed as Mixture)

The polymerization, desodoration and finishing were carried out as described for example 2, except for using the following monomer mixture: 12.0 g (20 pphm) of ethyl acrylate, 11.5 g (15 pphm) of butyl acrylate, 30.0 g (50 pphm) of methyl methacrylate and 9.0 g (15 pphm) of methacrylic acid. Thereby 1700 g of an aqueous polymer dispersion having a solids content of 18.5% by weight a pH of 4.7 and a viscosity of 300 mPas were obtained.

### Example 7 (150 Ppm CMC2, Monomer Feed as Mixture)

A reaction vessel equipped with a stirrer, nitrogen inlet and means for controlling the temperatures was charged with 2000 g of deionized water, 0.24 g of the aqueous solution of the Fe-Kat, 2.00 g of emulsifier 1 and 0.67 g of emulsifier 2. Then, 180 g of CMC2 were added with stirring to obtain a viscous solution, which was stirred for 12 h at 22° C. The concentration of CMC in the aqueous solution was 8.0% b.w. Then, 15.0 g (3.75 pphm) of initiator solution 1 were added, followed by heating of the resulting mixture to 85° C. with stirring. The viscosity of the obtained solution determined according to Brookfield at 85° C. using RVT spindle 6 at 10 rpm was 6500 mPas.

Then, 1.71 g of the initiator solution 2 was added, followed by starting the addition of the monomer mixture, while continuing stirring at maintaining the temperature at 85° C. The monomer mixture consisted of 42.0 g (35 pphm) of ethyl acrylate, 60.0 g (50 pphm) of methyl methacrylate and 18.0 g (15 pphm) of methacrylic acid. Within 120 min. the monomer mixture was metered into the reaction vessel. 15 min. after having started the addition of the monomer emulsion, 0.48 g of initiator solution 2 were rapidly added, followed by metering 24 g of the co-initiator solution into the reaction vessel within 135 min., while keeping the temperature at 85° C.

### Desodoration:

After the addition of the co-initiator solution had been completed, 0.48 g of initiator solution 1 were rapidly added, followed by metering 24 g of the co-initiator solution into the reaction vessel within 120 min., while keeping the temperature at 85° C. After having completed the addition of the co-initiator solution, the pressure in the reaction vessel was lowered to 700 mbar and unreacted ethyl acylate was removed by passing a stream of nitrogen through the reaction mixture.

### Finishing:

Then, the reaction mixture was cooled to 22° C., followed by addition of 0.65 g of the biocide solution and filtering the reaction mixture through a nylon mesh. Thereby, 1650 g of an aqueous polymer dispersion having a solids content of 13.4% by weight a pH of 4.7 and a viscosity of 120 mPas were obtained.

### Comparative Example C3: Example B5.15 of WO 2016079003

In a 4 liter HWS vessel equipped with an anchor agitator, reflux condenser, inside thermo sensor and metering station, 1240.6 g deionized water, 0.71 g of a 28% by weight aqueous solution of sodium lauryl ether sulfate and 150 g CMC150 were mixed. At 90° C. 1.43 g NaPS were added, and the mixture was stirred at 85° C. for 5 minutes. For 3 hours an emulsion consisting of 226.66 g deionized water, monomers (80 g methacrylic acid, 60 g n-butylacrylate, 60 g ethylacrylate, 8 g butanediol diacrylate, 13.57 g of a 28% b.w. aqueous solution of sodium lauryl ether sulfate) were added and constantly stirred at 90° C. Simultaneously, 90 g of a 1% by weight aqueous solution of NaPS was added within 3 hours. After complete addition of the emulsion and NaPS 10.72 g deionized water was added. Polymerization was continued for further 0.5 h at 90° C. At 90° C. 0.8 g of 25% aqueous H₂O₂ were added and during cooling 20 g of a 2% by weight aqueous solution of ascorbic acid were added at a constant rate for 2 hours. An aqueous polymer dispersion having a solids content of 16% b.w. was obtained.

### Comparative Example C4: Example B5.20 of WO 2016079003

In a 4 liter HWS vessel equipped with an anchor agitator, reflux condenser, inside thermo sensor and metering station, 1070.1 g deionized water, 0.54 g of a 28% by weight aqueous solution of sodium lauryl ether sulfate and 150 g CMC80 were mixed. At 75° C. 6.43 g of an 7% b.w. aqueous solution of NaPS were added and the mixture was stirred at 75° C. for 5 minutes. For 2 hours an emulsion consisting of 94.56 g deionized water, monomers (60 g methacrylic acid, 44.63 g n-butylacrylate, 44.63 g ethylacrylate, 0.94 g ASSOC, 10.18 g of a 28% b.w. aqueous solution of sodium lauryl ether sulfate) were added and constantly stirred at 75° C. After complete addition of the emulsion 8.04 g deionized water was added. Polymerization was continued for further 1 hour at 75° C. At 75° C. 0.6 g of 25% aqueous H₂O₂ were added and during cooling 15 g of a 2% by weight aqueous solution of ascorbic acid were added at a constant rate for 2 hours. An aqueous polymer dispersion having a solids content of 16% b.w. was obtained.

### Determination of the Anti-Greying Properties

The anti-greying performance of the aqueous polymer compositions of examples 1 - 7 and of comparative examples C3-C4 was tested by preparing wash solutions using water of 14°dH hardness (2.5 mmol/L; Ca:Mg:HCQ3 4:1:8) containing 5 g/L of the test detergent T (see Table 1) and 1.0 or 1.5% b.w. with respect to the detergent dosage of the polymer composition, calculated as polymer. For comparison (comparative example C1), wash solutions are prepared containing 5 g/L of the test detergent T and 1.0% b.w. and 1.5% b.w., respectively, with respect to the detergent dosage of carboxymethylcellulose CMC2 (Walocel® CRT 2000 PA). As a further comparative example C2, wash solutions were prepared as described for comparative example C1, but using CMC1 instead of CMC2.

TABLE 1

Detergent T

| | |
|---|---|
| Liquid Laundry Detergent Formulation | |
| Alkylbenzene sulfonic acid (C10-C13) | 5.7% |
| C13/15-Oxoalkohol reacted with 7 moles of Ethylene oxide | 5.4% |
| 1,2 Propylenglycol | 6% |
| Ethanol | 2% |
| Potassium coconut soap | 2.4% |
| KOH | 3.1 |
| Lauryl ether sulphate | 7.7% |
| Polymer composition | as stated |
| Water | to 100% |

The test fabrics were 10 cm × 10 cm squares of different cotton (wfk10A as standard cotton, wfK12A as cotton terry cloth, wfk80A as cotton knit, EMPA 221 as cotton fabric, cretonne, bleached without optical brightener, T-shirt from Brantic, Ka-part brand) and synthetic fabrics(wfk20A, wfk30A, EMPA406). The test was performed in a launder-O-meter with beakers of 1L size. Soil was a mixture of two 2.5 g EMPA 101 (purchased at EMPA Testmaterials, St Gallen, Switzerland) and of two 2.5 g SBL 2004 fabrics (purchased from wfk Testgewebe GmbH, Bruggen, Germany).

The first cycle was run using the launder-O-meter beakers containing the test wash solution (0.25 L) plus test fabrics and ballast soil at 40° C. for 20 min (fabric to liquor ratio of 1:10). After the wash, the test fabrics and ballast soil were separated. The process was repeated using the washed test fabrics and effectuating 5 cycles in total. New ballast soil was used for each cycle. After the 5 cycles, the test fabrics were rinsed in water, followed by drying at ambient room temperature overnight.

The greying of the cotton and synthetic test fabrics was measured by determining the degree of whiteness (reflectance values) after washing using a sphere reflectance spectrometer (SF 500 type from Datacolor, USA, wavelength range 360-700 nm, optical geometry d/8°) with a UV cut- off filter at 460 nm.

The anti-greying properties of the detergents tested were then quantified after addition of 1.0 to 1.5% b.w. of the respective polymer composition (see Table 2). Reflectance values decrease with the visible greying of the fabrics, the higher the reflectance value, the better the anti-greying performance of the detergent. Fabrics DR values represent the difference between the reflectance after wash of the test detergent T containing the corresponding polymer and the reflectance after the wash of the test detergent without the polymer for the summation of the 8 different test fabrics.

For the determination of storage stability and compatibility in liquid detergent formulations, the aqueous polymer compositions were incorporated to the detergent formulation of table 2 and stored at 37° C. for 4 weeks. As shown in Table 2, insolubility phase separation is a major problem for CMC2 (Walocel® CRT 2000 PA) and makes the use of CMC in liquid detergents not possible.

Viscosities for the detergents were determined according to DIN ISO 2555:2018-09 using a Brookfield viscometer at 22° C. and 20 rpm using spindle 1.

TABLE 2

| | Polymer comp. | ΔR (%) ¹) 1.0% b.w. | ΔR (%) ²) 1.5% b.w. | Stability ³) (1.5 %) | Viscosity ⁴) (mPas) | Transparency (1.5%) ⁵) |
|---|---|---|---|---|---|---|
| C1 | CMC2 | 32 | 33 | -- | n.d. | 2 phases |
| C2 | CMC1 | 34 | 36 | -- | n.d. | 2 phases |
| 1 | Ex. 1 | 25 | 31 | + | 1712 | clear |
| 2 | Ex. 2 | 28 | 34 | + | 1677 | clear |
| 3 | Ex. 3 | 24 | 29 | + | 1843 | clear |
| 4 | Ex. 4 | 21 | 28 | ++ | 1408 | clear |
| 5 | Ex. 5 | 23 | 29 | ++ | 1498 | clear |
| 6 | Ex. 6 | 29 | 31 | ++ | 1605 | clear |
| 7 | Ex. 7 | 25 | 31 | + | 1650 | clear |
| C3 | B.5.15 | 14 | 19 | + | 2870 | opaque |
| C4 | B.5.20 | 12 | 18 | ++ | 3232 | opaque |

1) Delta Reflectance at 1.0% b.w. polymer with respect to detergent dosage
2) Delta Reflectance at 1.5% b.w. polymer with respect to detergent dosage
3) Stability at 1.5% b.w. polymer with respect to detergent. Stabilities were rated as follows: ++: clear, soluble, no phase separation, no effect on viscosity +: almost clear, soluble, no phase separation, no effect on viscosity -: turbid, insoluble parts, slight increase on viscosity - turbid, soluble, phase separation, strong increase of viscosity (gelation)
4) Viscosity of the detergent composition containing 1.5% b.w. polymer with respect to detergent
5) Transparency of the detergent composition containing 1.5% b.w. polymer with respect to detergent

1. An aqueous polymer composition, which is obtainable by radical copolymerization in water of
i) ethylenically unsaturated monomers M comprising
a.1) 50 to 95% by weight, based on the total weight of the monomers M, of at least one monomer M1, selected from the group consisting of C₁-C₃-alkyl esters of acrylic acid and C₁-C₃-alkyl esters of methacrylic acid and mixtures thereof, and
a.2) 5 to 50% by weight, based on the total weight of the monomers M, of at least one monomer M2, selected from the group consisting of monoethylenically unsaturated C₃-C₈-monocarboxylic acids and monoethylenically unsaturated C₄-C₈-dicarboxylic acids, and mixtures thereof;
where the radical copolymerization in water is carried out in the presence of
ii) 110 to 600% by weight, based on the total amount of monomers M, of a carboxymethyl cellulose.

2. The polymer composition of claim 1, where the monomers M1 comprise
at least one monomer M1a, which is selected from the group consisting of methyl methacrylate and methyl acrylate and mixtures thereof;
at least one monomer M1b, which is selected from the group consisting of C₂-C₃-alkyl esters of acrylic acid and C₂-C₃-alkyl esters of methacrylic acid.

3. The polymer composition of claim 2, where the monomer M1a is methyl methacrylate, and the monomer M1b is ethyl acrylate.

4. The polymer composition of claim 2, where the weight ratio of the monomer M1a to the monomer M1b is in the range from 1:2 to 3:1.

5. The polymer composition of claim 1, where the monomer M2 is selected from the group consisting of monoethylenically unsaturated C₃-C₆-monocarboxylic acids .

6. The polymer composition of claim 1, where the monomers M1 and M2 amount to at least 70% of the monomers M.

7. The polymer composition of claim 1, where the carboxymethylcellulose as its sodium salt has a weight average molecular weight in the range from 10000 to 1500000 Dalton as determined by field flow fractionation of a 0.5% by weight solution of the carboxymethylcellulose in a 0.1 M solution of NaNO₃ in deionized water at 25° C.

8. The polymer composition of claim 1, where the carboxymethylcellulose is characterized in that its 2% by weight aqueous solution has a Brookfield viscosity, determined by a rotational viscosimeter at 25° C. and rotational speed of 20 rotations pro minute, in the range from 10 to 20000 mPas.

9. The polymer composition of claim 1, where the carboxymethylcellulose has a degree of anionic substitution in the range from 0.5 to 1.5.

10. A process for producing a polymer composition of claim 1, which comprises a radical copolymerization of the monomers M in water in the presence of 110 to 600% by weight, based on the total amount of monomers M, of a carboxymethyl cellulose.

11. The process of claim 10, where the majority of the monomers M to be polymerized are fed to an aqueous solution of carboxymethyl cellulose under polymerization conditions.

12. The process of claim 10, where a radical polymerization initiator is used, which comprises a peroxide.

13. A method of using the aqueous polymer composition of claim 1, the method comprising using the aqueous polymer composition as an anti-greying additive in the washing of laundry.

14. A method of using the aqueous polymer composition of claim 1, the method comprising using the aqueous polymer composition as an anti-greying additive in a laundry detergent formulation, .

15. A laundry detergent formulation, which contains at least one aqueous polymer composition of claim 1.

16. The polymer composition of claim 1, where the monomer M2 comprises methacrylic acid.

17. A method of using the aqueous polymer composition of claim 1, the method comprising using the aqueous polymer composition as an anti-greying additive in a liquid laundry detergent formulation or a gel-type laundry detergent formulation.

18. A liquid or gel-type laundry detergent formulation, which contains at least one aqueous polymer composition of claim 1.
